(19) United States
(12) Patent Application Publication
(10) Pub. No.: US 2013/0025969 A1
(43) Pub. Date: Jan. 31, 2013

(54) LADDER SAFETY KIT

(71) Applicant: Edward H. Horn, Hot Springs Village, AR (US)

(72) Inventor: Edward H. Horn, Hot Springs Village, AR (US)

(21) Appl. No.: 13/190,625

(22) Filed: Jul. 26, 2011

(51) Int. Cl. E06C 7/18

(52) U.S. Cl. 182/8

(57) ABSTRACT

The invention comprises a kit having tools attachable to a ladder to stabilize the same. The tools include a stabilizer tool attachable to the ladder and capable of circumscribing a vertical object to thereby stabilize the ladder. Additionally, there are provided extensions attachable to the stabilizer tool having clamps, movable to engagement of a building or the like by its gutters or other protuberances.

The present invention addresses the issue of ladder safety and offers a package, in kit form, to remediate the problems associated with use of a ladder, particularly out of doors.

### BACKGROUND OF THE INVENTION

1. Field of the Invention

Comedians, since time immemorial, have glorified the prat fall in their routines, often from a ladder, and it has always been good for a laugh . . . not so funny for the one who falls.

Statistics compiled by the Consumer Products Safety Commission reveal that about 165,000 Americans are injured every year in ladder related accidents annually. That represents a lot of unnecessary pain and suffering, not to mention otherwise productive hours lost every year.

2. Overview of the Prior Art

A search of the prior art demonstrates a surprising lack of truly relevant art. There are some patents which snap at specific issues, but none offer the worker, or the consumer, a package which would render work on ladders more safe in practically all environments.

By way of example, Barrow U.S. Pat. No. 3,037,579 is a 1960's effort suggesting that one can tie a ladder to a pole with a length of rope. Sheridan et al. patent 7,575,097 goes one step further by adding an elastomer piece having teeth formed on an arcuate surface to thereby enhance the grip of a ladder stabilizer. Sandor Sr., on the other hand, just eliminated the circumscribing strap to use the toothed stabilizer alone, and Palmquist U.S. Pat. No. 2,808,975 is more of the same.

There are also some publications which relate to the stabilization of ladders, among them, Sais 2006/0032707 which suggests a gutter clamp. Charlton 2009/0188750 proposes a somewhat different gutter clamp, and Salisbury 2009/00143240 differs to some extent by using a “C” clamp for engaging a window sill.

None of these various publications even remotely suggest a package, or kit, which would equip the user with the ability to tackle almost any task involving safety in the use of a ladder.

### SUMMARY OF THE INVENTION

The present invention offers to the public a convenient and affordable assemblage of tools and attachments for use in concert with a ladder to substantially increase the safety of one working on a ladder.

Simply stated, therefore, the principal objective of the present invention is to provide the means by which the safe use of a ladder is greatly enhanced. An objective related to the foregoing is to enhance the safe use of a ladder in several different environments.

It is yet another objective of the present invention to provide ladder safety oriented tools in a single convenient and affordable kit.

Still another objective of the present invention is to provide a system of tools which are capable of meeting the objectives attributable to them, in a readily transportable kit form.

The foregoing, as well as other objectives and advantages, will be apparent to those skilled in the art from a reading of the Detailed Description of A Preferred Embodiment, taken in conjunction with the drawings, wherein:

### BRIEF DESCRIPTION OF THE DRAWING

Presented herewith are three sheets of drawings illustrating the present invention in various environments from which it has particular, although not exclusive, utility:

FIG. 1 is a pictorial representation of an individual using a ladder, accomplishing a task on, or in close proximity to, a vertical object, such as a post or tree, with the ladder safely secured on the tree by means of a strap which circumscribes the tree. Also illustrated is a safety belt for the user.

FIG. 2 is similar to FIG. 1, except the strap is engaged with a tree limb or the like projecting at an acute angle from the vertical post or tree trunk;

FIG. 3 is illustrative of the present invention in which the ladder in use is secured to the gutter assembly of a typical house;

FIG. 4 is a pictorial representation of the tool assembly which is illustrated in use in FIG. 3;

FIG. 5 is a side elevation of a portion of the tool of FIG. 3;

FIG. 6 is a top plan view of the tool of FIG. 3, illustrating the flexibility and, thus, the utility, of the tool;

FIG. 7 is a top plan view of the tool of FIG. 6, and,

FIG. 8 is a pictorial representation of the kit containing the tools of the present invention.

### DETAILED DESCRIPTION OF A PREFERRED EMBODIMENT

With reference now to the drawings, and initially to FIG. 1, a typical environment is established as one in which a user would expect to encounter a circumstance requiring interface with a ladder L, supported by an upstanding, essentially vertical object, e.g., tree T.

A user U finds a need to perform a task in the upper reaches of, or in proximity to, the tree T and, in so doing, mounts the ladder L. The trunk of the tree is rounded and, thus, presents an unstable surface against which the ladder must rest.

In order to alleviate any sense of instability which might be felt by the user, the kit K of the present invention provides, as part of a package, a stabilizer tool 20. The stabilizer tool 20 includes an engageable bracket 22 attachable, by any one of several well known fasteners, e.g., hose type clamps 23, to a rung 24 of the ladder L. The bracket 22 is equipped with a bowed, rotatable strap guide 25 having eyelets 26 through which is threaded an adjustable strap 28, which extends outwardly from the ladder to circumscribe the trunk of the tree T.

As an additional hedge against injury to the user, the kit includes a safety belt assembly 31, selectively attachable to the bracket 22 of the ladder, and which encircles the user, holding the user against inadvertent dislodgement from the ladder.

Also, an additional safeguard is provided in the nature of a hand guard 33, capable of accommodating both hands, projecting upwardly from the bracket 22 where the user U can easily grip the hand rail to further stabilize him/her while on the ladder.

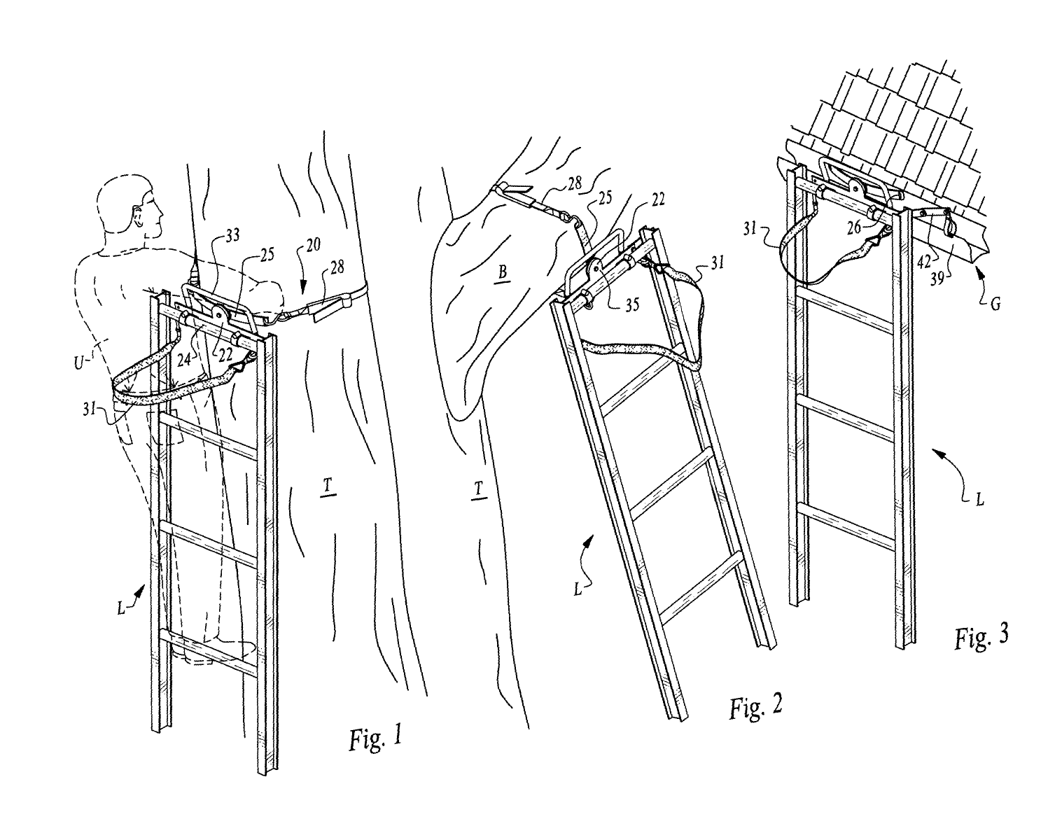

The stabilizer tool 20 of the present invention is distinguished by its versatility as illustrated in FIG. 2. The work to be performed is not always conveniently reachable from the a vertical tree trunk or post. Sometimes it may be on, or very near, a branch B, or similar nonvertical extension of the post or tree trunk. The stabilizer tool 20 of the present invention provides for such an eventuality in that the strap guide 25 is attached to the bracket in a manner which permits it to be rotatable through 360 degrees.

Referring to FIGS. 2 and 7, by way of example, a pivot pin 35 is centrally positioned and fixed in the bracket 22 and also in the strap guide 25, which permits the strap guide to be rotated through 360 degrees in a plane essentially parallel to the plane of the ladder.

Not all work requiring a ladder is conveniently in proximity to the trunk of a tree or upstanding post Thus, as witnessed in FIG. 2, the strap 28 circumscribes a branch B of the tree T when the strap guide 25 is rotated, thereby permitting the ladder L to be moved away from the tree trunk or post, as the case may be, yet fully secured by engagement with the branch located in proximity to that requiring work.

One of the more common tasks around the home is cleaning out gutters, or otherwise performing work on the gutters of a house. The tools of the present invention anticipate such needs and provides for them.

Thus, referring to FIG. 3, a ladder is illustrated in position for servicing the gutter of a home (not shown), with the ladder secured, by means of left and right selectively positionable attachments, or extensions, 42 to the tool 20 of the present invention, to, e.g., the gutter itself.

In its simplest form, the attachments employ an object engaging device such as a clamp 37 for the purpose of engaging the wall 39 of, for example, a gutter G.

The tool of the present invention with attachments, or extensions, 42 in place, is sufficiently rigid in its construction to provide the necessary confidence a user will need when working on the ladder L, while, being articulatable to permit the clamps 37 to reach and secure the ladder against slippage while engaged to a permanent surface of the house, such as the wall of the gutter 39. A similar engagement may be accomplished by using a window sill or similar house structure, which is capable of securing the ladder by means of the clamps 37.

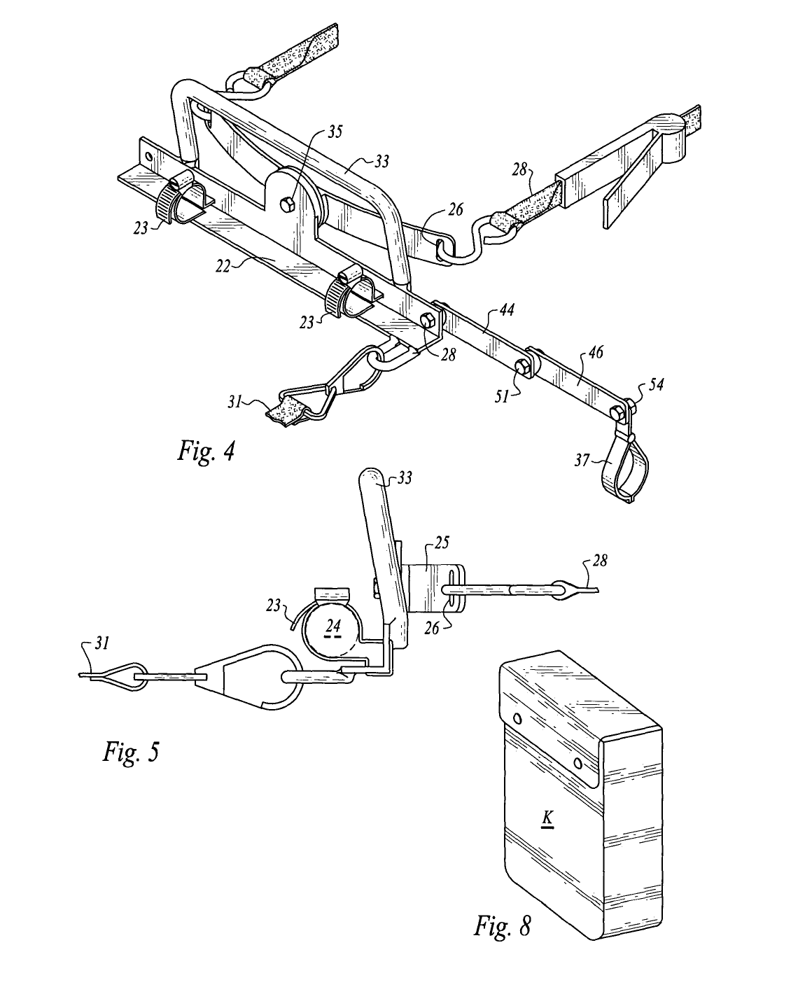

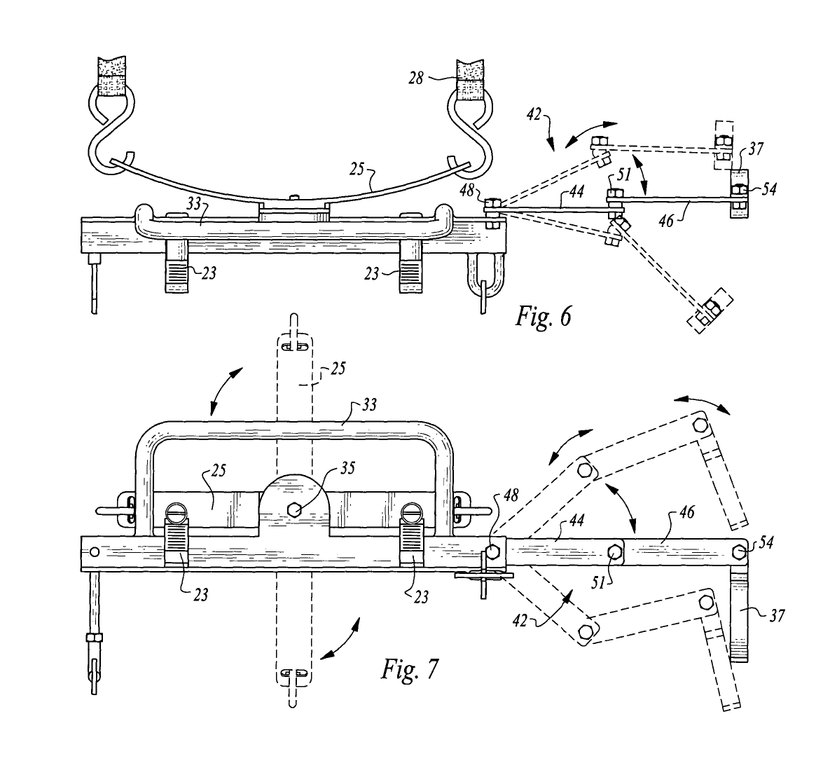

Thus, by referring to FIGS. 4, 6 and 7, an exemplary extension 42 is shown, and in FIGS. 6 and 7, articulated in order to show its versatility.

Referring first to FIG. 4, it will be seen that the extension 42 includes first and second links 44, 46. In order to activate the extension the link 44 is rotatably fastened to the bracket 22 by any suitable fastener 48, and the link 47 is secured to the link 44 by means of a fastener 51. By using a ball joint type fastener, at 46 and 51, it will be seen, especially in FIGS. 6 and 7, that the clamp 37, which is rotatably secured to the link 46 by a fastener 52, may be moved in planes which may be vertically, and to some extent horizontally, and in several planes in between, relative to the plane of the ladder to locate and secure the clamp 37 to a suitable stationary or fixed portion of the house. In this manner, the ladder is inhibited from slipping from its assigned position and, further, offers the user the necessary stability for him/her to have confidence in the user's footing while working on the ladder.

The foregoing description describes a preferred embodiment. Some variations will occur to those skilled in the art upon a reading of the description. Variations are within the contemplation of the invention as described in the forthcoming claims, wherein:

1. Please cancel claim 1 without prejudice.

2. Please cancel claim 2 without prejudice.

3. The portable kit of claim 11, said kit containing at least one extension, said extension being attachable to said stabilizer tool at an end thereof, an object engaging device attached at the end of said extension opposite said attachable end.

4. The portable kit of claim 3, wherein said object engaging device comprising a lockable clamp.

5. The portable kit of claim 4, there being two extensions in said kit, said extensions being attachable at the left and right side of said stabilizer tool.

6. The portable kit of claim 3, said extension containing at least one link, said link being rotatably attachable to said stabilizer tool so as to be movable relative thereto.

7. Please cancel claim 7, without prejudice.

8. Please cancel claim 8, without prejudice.

9. The portable kit of claim 3, said object engaging device being movable relative to said extension to engage an unmovable object located in proximity to said extension.

10. In portable kit form, a ladder safety package comprising a stabilizer tool, said stabilizer tool attachable to the rung of a ladder;
a strap guide, said strap guide adapted to circumscribe a vertical object, said strap guide being attachable to said stabilizer tool;
a safety belt, said safety belt attachable to said stabilizer tool to hold a user on the ladder;
said kit further containing at least one extension, said extension being attachable to said stabilizer tool and having a clamp at a remote unattached end thereof, said extension comprising a series of links, said links being articulatable to position said clamp for engagement with a permanent structure to thereby hold the ladder against inadvertent movement.

11. In portable kit form, a ladder safety package comprising a stabilizer tool, said stabilizer tool being attachable to the rung of a ladder;
a strap guide, said strap guide adapted to extend outwardly to circumscribe a vertical object, said strap being mounted to said stabilizer tool;
said stabilizer tool contains a bracket, said bracket being connected to said stabilizer tool and said strap guide being attachable to said bracket, said bracket being rotatable in a plane parallel to said ladder relative to said stabilizer tool through 360 degrees of rotation;
a safety belt, said safety belt attachable to said stabilizer tool and extended about the user to hold a user on the ladder.
